(19) United States
(12) Patent Application Publication
(10) Pub. No.: US 2020/0381903 A1
(43) Pub. Date: Dec. 3, 2020

(54) ION DETECTOR AND ION GENERATOR

(71) Applicant: SHARP KABUSHIKI KAISHA, Sakai City (JP)

(72) Inventor: NAOYUKI MORIMOTO, Sakai City (JP)

(21) Appl. No.: 16/879,399

(22) Filed: May 20, 2020

(30) Foreign Application Priority Data
May 28, 2019 (JP) 2019-099384

(51) Int. Cl. H01T 23/00

(52) U.S. Cl. CPC H01T 23/00

(57) ABSTRACT

An ion detector that is installed in an ion generator, the ion detector includes: a detection unit configured to acquire a first detected signal corresponding to a change in an electric field caused by an electric discharge of the ion generator; and a frequency filtering circuit configured to perform frequency filtering on the first detected signal to output a post-filtering first detected signal, wherein the frequency filtering circuit comprises at least one band-pass filter and at least one band-elimination filter, the at least one band-elimination filter having a frequency characteristic different from a frequency characteristic of the at least one band-pass filter.

### CROSS-REFERENCE TO RELATED APPLICATION

The present application claims priority from Japanese Application JP2019-099384, the content to which is hereby incorporated by reference into this application.

### BACKGROUND OF THE INVENTION

### 1. Field of the Invention

One aspect of the present invention relates to an ion generator installed in an ion generator.

### 2. Description of the Background Art

Various techniques have been proposed in order to detect the state of ion generation in an ion generator. Japanese Patent Application Laid-Open No. 2017-50196, for instance, discloses an example of a noncontact ion generator (which is an ion generator that does not need to collect ion particles). To be specific, the ion detector in Japanese Patent Application Laid-Open No. 2017-50196 detects an electric field caused by an electric discharge of the ion generator, to output a signal detected according to the state of ion generation.

### SUMMARY OF THE INVENTION

It is an object of one aspect of the present invention to provide a noncontact ion detector having detection accuracy higher than that of a conventional noncontact ion detector.

To solve the problem, one aspect of the present invention provide an ion detector that is installed in an ion generator. The ion detector includes a detection unit that acquires a first detected signal corresponding to a change in an electric field caused by an electric discharge of the ion generator. The ion detector also includes a frequency filtering circuit that performs frequency filtering on the first detected signal to output a post-filtering first detected signal. The frequency filtering circuit includes at least one band-pass filter and at least one band-elimination filter. The at least one band-elimination filter has a frequency characteristic different from a frequency characteristic of the at least one band-pass filter.

The ion detector according to the aspect of the present invention enables a noncontact ion detector to have detection accuracy higher than that of a conventional noncontact ion detector.

### BRIEF DESCRIPTION OF THE DRAWINGS

FIG. 1 is a block diagram illustrating the configuration of main components of an ion generator according to a first preferred embodiment;

FIG. 2 is a graph showing an example of an ideal gain characteristic in a frequency filtering circuit in FIG. 1;

FIG. 3 illustrates the configuration of a notch filter (NF) in the frequency filtering circuit;

FIG. 4 is a graph showing an example of a gain characteristic of a first NF in the frequency filtering circuit;

FIG. 5 illustrates the configuration of a hysteresis comparator (referred to as an H comparator) in the ion detector in FIG. 1;

FIG. 6 is a graph for describing an input-output characteristic of the H comparator,

FIG. 7 is a graph schematically showing the actual input-output waveform in the H comparator,

FIG. 8 illustrates the configuration of a BEF according to a modification;

FIG. 9 illustrates the configuration of a BEF according to another modification;

FIG. 10 is a block diagram illustrating the configuration of main components of an ion generator according to a second preferred embodiment; and

FIG. 11 is a block diagram illustrating the configuration of main components of an ion generator according to a third preferred embodiment.

### DETAILED DESCRIPTION OF THE INVENTION

### First Preferred Embodiment

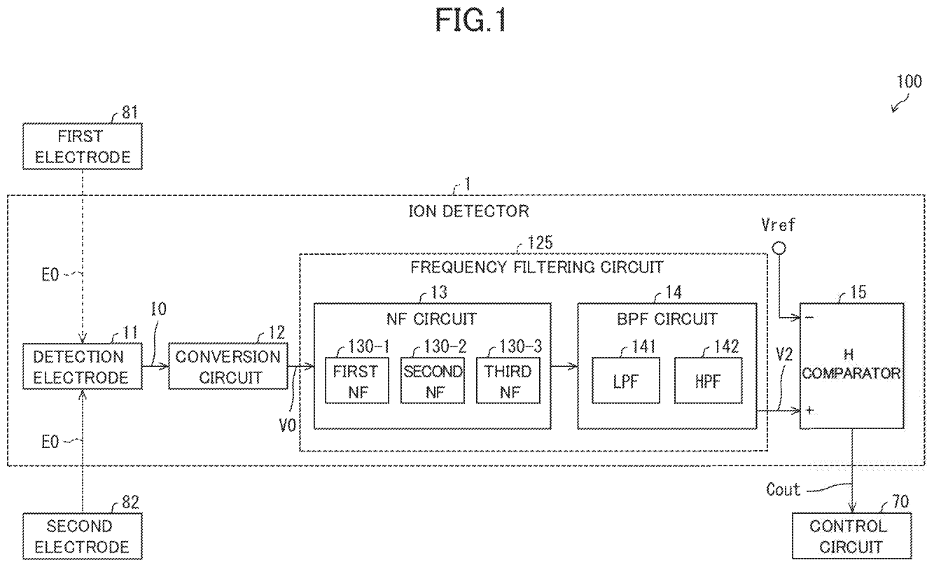

The following describes an ion detector 1 according to a first preferred embodiment. As illustrated in FIG. 1, the ion detector 1 is installed in an ion generator 100. The ion generator 100 generates ions (e.g., positive and negative ions) through electric discharge, the details of which will be described later on. The ion generator 100 can be thus referred to as an example of an electric-discharge apparatus. The ion generator 100 may be installed in a publicly known, electric appliance (e.g., an air purifier).

For convenience, components whose functions are the same as those in the first preferred embodiment will be denoted by the same signs and will not be elaborated upon in the subsequent preferred embodiments. Descriptions similar to those in a publicly known technique (e.g., Japanese Patent Application Laid-Open No. 2017-50196) will not be elaborated upon here. Each drawing illustrates a device configuration and a circuit configuration by way of example only. In addition, the positional relationship between the components is not limited to what is illustrated in each drawing. Furthermore, the Specification gives numeric values by way of example only. Unless otherwise clearly indicated, the wording “A to B”, where A and B each denote a numeral, means “A or more and B or less”.

Overview of Ion Generator 100

FIG. 1 is a block diagram illustrating the configuration of main components of the ion generator 100. The ion generator 100 includes an ion detector 1, a control circuit 70, a first electrode 81, and a second electrode 82.

The ion generator 100 is connected to a publicly known power source not shown (e.g., a commercial power source), and receives power from the power source. The power source is an alternating-current (AC) power source for instance that outputs an AC voltage having a predetermined frequency (or power source frequency). The power source frequency is 50 or 60 Hz. In the following example, the power source outputs a sinusoidal AC voltage.

The control circuit 70 controls the individual components of the ion generator 100 (particularly discharge operation) collectively. The control circuit 70 drives an electric-discharge circuit not shown, thus causing electric discharges at the first electrode 81 and second electrode 82. To be specific, the control circuit 70 acquires an output detected signal (e.g., an output detected signal abbreviated to Cout, which will be described later on) from the ion detector 1. The output detected signal indicates a result of detection of the control circuit 70. The output detected signal is used as an index of the state of ion generation. The control circuit 70 then controls each component (e.g., a discharge circuit) of the ion generator 100 in response to the output detected signal. The ion detector 1 generates an output detected signal based on an input detected signal (abbreviated to V0), the details of which will be described later on.

The first electrode 81 and second electrode 82 are electrodes (or discharge electrodes) that generate respective ions with different polarities through electric discharge. The first electrode 81 and second electrode 82 are provided in a pair (e.g., a pair of needle electrodes) for instance. In the first preferred embodiment, the first electrode 81 generates plus or positive ions through electric discharge. In the first preferred embodiment, the second electrode 82 generates minus or negative ions through electric discharge. The first electrode 81 is also referred to as a plus discharge electrode; and the second electrode 82, a minus discharge electrode.

Configuration of Ion Detector 1

The ion detector 1 includes a detection electrode 11 (i.e., a detection unit), a conversion circuit 12 (i.e., a detection unit), a notch filter circuit (also referred to as an NF circuit) 13, a band-pass-filter circuit (also referred to as a BPF circuit) 14, and a hysteresis comparator (also referred to as an H comparator) 15. The NF circuit 13 and BPF circuit 14 are together referred to as a frequency filtering circuit 125.

The detection electrode 11 is an electrode for detecting an electric field (hereinafter referred to as E0) caused by an electric discharge of the ion generator 100 (to be more specific, electric discharges at the first electrode 81 and second electrode 82), To be specific, the detection electrode 11 is provided so as to cross or intersect a line of electric force corresponding to E0. The detection electrode 11 is a plate electrode for instance that is disposed near the first electrode 81 and second electrode 82. An induced current is generated at the detection electrode 11 when E0 changes.

The conversion circuit 12 acquires the induced current, generated at the detection electrode 11, as a current signal (hereinafter referred to as I0). I0 changes along with change in E0. The conversion circuit 12 converts I0 into a voltage signal (hereinafter referred to as V0), and supplies the voltage signal to the NF circuit 13.

The conversion circuit 12 is an example of a detection unit (i.e., a signal acquiring unit) that acquires V0, which is a signal (i.e., a first detected signal) that corresponds to a change in E0. The first detected signal is referred to as an input detected signal. As illustrated in FIG. 1, the first detected signal is input to the frequency filtering circuit 125. V0 in the first preferred embodiment is an example of the first detected signal. To be more specific, V0 in the first preferred embodiment is an analog signal that corresponds to a change in I0. The conversion circuit 12 can be a publicly known current-voltage conversion circuit (e.g., a voltage dividing circuit).

The NF circuit 13 includes at least one notch filter (hereinafter referred to as an NF). In the following description, the NF circuit 13 includes P-number of NFs, where the alphabet P denotes an integer that equals or exceeds one. In the Specification, an NF that comes in the i^{th} place in the NF circuit 13 will be referred to as an i^{th} NF 130-i (or just referred to as an i^{th} NF), where the alphabet i denotes an integer that is one or more and P or less. In addition, the NFs in the NF circuit 13 will be together also referred to as an NF 130. FIG. 1 illustrates an instance of P=3. The NF circuit 13 in FIG. 1 includes three NFs: a first NF 130-1, a second NF 130-2, and a third NF 130-3. An example of the circuit configuration of the NF 130 will be described later on.

The first to P^{th} NFs have their frequency characteristics different from one another. To be more specific, the first to P^{th} NFs have their notch frequencies (i.e., reference frequencies) different from one another. In the following description, the notch frequency of the i^{th} NF will be referred to as fNi.

The NFs in the Specification are each an example of a band-elimination filter (or BEF for short). An NF is a kind of BEF having a particularly narrow cutoff frequency band. A BEF is referred to as a band-stop filter or BSF for short. The NF circuit 13 is thus also referred to as a BEF circuit (or BSF circuit).

The BEFs are expressed in a manner similar to the NFs. For instance, a BEF that comes in the i^{th} place will be referred to as the i^{th} BEF. Further, the reference frequency in the cutoff frequency band of the i^{th} BEF will be referred to as fBEi. That is, the i^{th} BEF cuts off (or to be specific, attenuates) an input signal in the cutoff frequency band with reference to fBEi. The i^{th} BEF transmits the input signal in a frequency band excluding the cutoff frequency band (which is called a non-cutoff frequency band). Aforementioned fNi is an example of fBEi.

The NF circuit 13 performs frequency filtering on V0 using the first to P^{th} NFs (e.g., the first NF 130-1 to third NF 130-3). For convenience, the frequency filtering in the NF circuit 13 will be referred to as first frequency filtering. In addition, V0 after the first frequency filtering will be referred to as a signal V1 (this signal will be hereinafter referred to as V1). The NF circuit 13 supplies V1 to the BPF circuit 14.

The BPF circuit 14 includes at least one BPF. In the following description, the BPF circuit 14 includes Q-number of BPFs, where the alphabet Q denotes an integer that equals or exceeds one. In the Specification, a BPF that comes in the j^{th} place in the BPF circuit 14 will be referred to as the j^{th} BPF, where the alphabet j denotes an integer that is one or more and Q or less. Examples of the BPF include a low-pass filter (or LPF for short) and a high-pass filters (or HPF for short). FIG. 1 illustrates an instance of Q=2. The BPF circuit 14 in FIG. 1 includes two BPFs: a LPF 141 (i.e., the first BPF) and an HPF 142 (i.e., the second BPF).

The first to Q^{th} BPFs have their frequency characteristics different from one another, the details of which will be describe later on. To be more specific, the first to Q^{th} BPFs have their cutoff frequencies different from one another. In the following description, the cutoff frequency of the j^{th} BPF will be referred to as fBPj. As a matter of course, the frequency characteristics of the first to Q^{th} BPFs are different from the frequency characteristics of the first to P^{th} BEFs. The NF circuit 13 thus has a frequency characteristic different from that of the BPF circuit 14.

The BPF circuit 14 performs frequency filtering on V0 (to be more specific, on V1) using the first to Q^{th} BPFs (e.g., the LPF141 and HPF142). For convenience, the frequency filtering in the BPF circuit 14 will be referred to as second frequency filtering. In addition. V1 after the second frequency filtering will be referred to as a signal V2 (abbreviated to V2). The BPF circuit 14 supplies V2 to the H comparator 15.

In the Specification. V0 (i.e., the first detected signal) that has undergone frequency filtering in the frequency filtering circuit 125 (i.e., the first frequency filtering and second frequency filtering) will be referred to as a post-filtering first detected signal. V2 in the first preferred embodiment is an example of the post-filtering first detected signal. The post-filtering first detected signal is also referred to as a post-filtering input detected signal.

The H comparator 15 is a two-input and one-output comparator, and has a hysteresis characteristic that will be described later on. The H comparator 15 has a positive (+) input terminal that receives V2 from the BPF circuit 14. The H comparator 15 has a negative (−) input terminal that receives a reference voltage Vref (or reference signal). The reference voltage Vref will be hereinafter abbreviated to Vref. The other signals will be abbreviated as well. Vref needs to be a predetermined positive value for instance, and be set according to the specifications of the ion detector 1 as appropriate. The Vref value needs to be usable as a reference for the V2 value (which is a signal value or signal level).

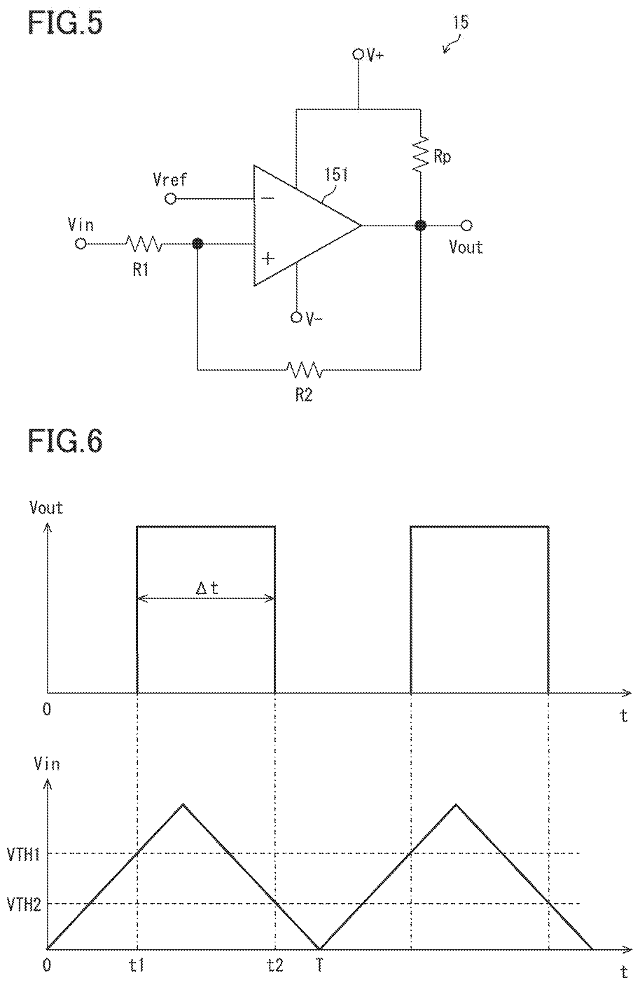

To be more specific, the positive and negative input terminals of the H comparator 15 are respectively positive and negative input terminals of an operational amplifier 151 that will be described later on. An example of the circuit configuration of the H comparator 15 will be described later on with reference to FIG. 5.

The H comparator 15 generates Cout in accordance with V2 and Vref. To be more specific, the H comparator 15 evaluates the V2 value based on Vref, to generate Cout based on V2. Cout will be also referred as a second detected signal. The H comparator 15 then outputs Cout to the control circuit 70. Cout in the first preferred embodiment is used to supply a signal indicating a result detected by the ion detector 1, to an external device (e.g., the control circuit 70). In this way, Cout in the first preferred embodiment is an example of the output detected signal.

Cout is either a low-level value or a high-level value. Low-level Cout corresponds to zero in digital value, and high-level Cout corresponds to one in digital value. That is, the H comparator 15 generates a single digital output (i.e., Cout) in accordance with two analog inputs: V2 and Vref. As described above. Cout is generated based on V2. Cout can be thus expressed as being generated based on V0.

By way of example only, I0=0 is satisfied when no electric discharge is occurring in the ion generator 100. That is, V0=0 is satisfied. As a result, V2=0 is satisfied. That is, V2 is sufficiently small. Cout=0 is satisfied in this case. The fact that Cout=0 means that no electric discharge is occurring in the ion generator 100 (or the electric discharge in the ion generator 100 is at a weak level).

I0 is sufficiently larger than zero when electric discharge is occurring in the ion generator 100. That is, V0 is sufficiently larger than zero. As a result, V2 is sufficiently large. Cout=1 is satisfied in this case. The fact that Cout=1 means that electric discharge is occurring in the ion generator 100. As described above, Cout is used as an index indicating whether electric discharge is occurring in the ion generator 100.

The control circuit 70 changes the drive state in the discharge circuit on the basis of Cout. Reference is made to an instance where the ion generator 100 is under operation. In Cout=1, the control circuit 70 continues to drive the discharge circuit. This is because, in Cout=1, the discharge operation in the ion generator 100 is probably being performed properly. In Cout=0 on the other hand, the control circuit 70 stops driving the discharge circuit. This is because, in Cout=, the discharge operation in the ion generator 100 is probably not being performed properly.

Example of Ideal Gain Characteristic in Frequency Filtering Circuit 125

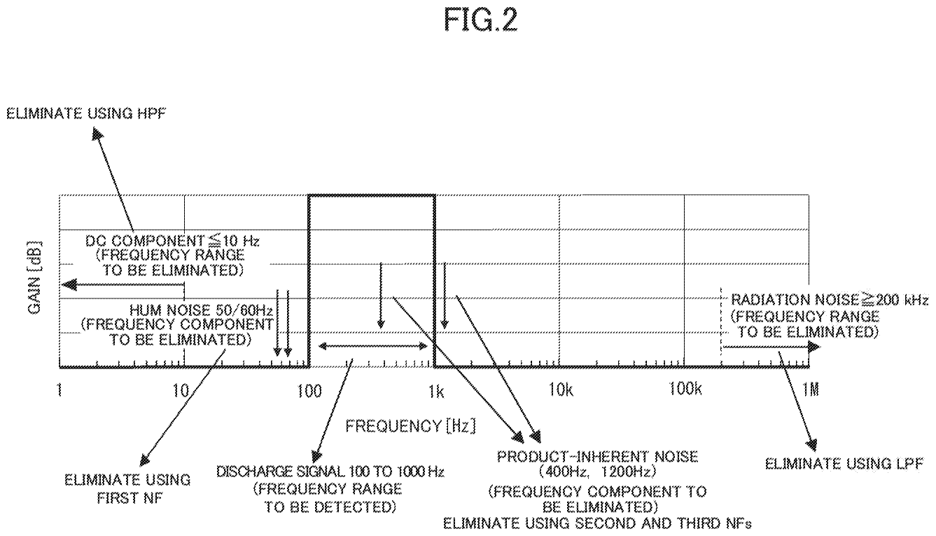

A noise effect on a detected signal needs to be prevented in order for the ion detector 1 to detect an electric discharge properly. That is, the ion detector 1 needs to be sufficiently resistant to noise. However, multiple kinds of noise containing various frequency components occur in the ion generator 100. Accordingly, the frequency filtering circuit 125 in FIG. 1 prevents the effects of these kinds of noise. The following describes the details with reference to FIG. 2.

FIG. 2 is a graph showing an example of an ideal gain characteristic in the frequency filtering circuit 125. In the example of FIG. 2, V0 indicates an input signal, and V2 indicates an output signal. In FIG. 2, the lateral axis indicates frequency expressed in hertz (Hz), and the vertical axis indicates gain expressed in decibels (dB).

In the following example, a signal resulting from an electric discharge of the ion generator 100 (to be more strict, an electromagnetic wave) will be referred to as a discharge signal. In the example in FIG. 2, the discharge signal has a frequency band (hereinafter referred to as discharge frequency band) mainly ranging from 100 to 1000 Hz. The discharge signal, one of components contained in the input signal, is regarded as a signal component for the ion detector 1 to detect an electric discharge. The discharge signal is desirably acquired from the input signal effectively in order for the ion detector 1 to detect an electric discharge properly. For this reason, the discharge frequency band in the example in FIG. 2 is provided with a particularly high gain.

In the ion detector 1, the other components contained in the input signal is regarded as noises for the discharge signal. These signals (or noises) are hence desirably eliminated. Accordingly, a frequency band excluding the discharge frequency band (hereinafter referred to as a non-discharge frequency band) in the example in FIG. 2 is provided with a particularly low gain. The ideal gain characteristic in FIG. 2 forms a graph in the form of a pulse that takes a high-level value in only the discharge frequency band. Using the frequency filtering circuit 125 can acquire V2 that mainly contains the discharge signal.

As described above, the ion generator 100 receives power from the power source. The ion generator 100 boosts the voltage (e.g., 100 V) of the power source using a transformer within the discharge circuit. The ion generator 100 applies the boosted voltage (e.g., 3 kV) to the first electrode 81 and second electrode 82, thus causing electric discharges at the first electrode 81 and second electrode 82.

There are various kinds of electromagnetic environmental noise around the ion generator 100. A hum noise is one of such noises. The frequency of the hum noise (hereinafter referred to as hum noise frequency) depends mainly on the power-source frequency in a region where the ion generator 100 is used. For easy description, the power-source frequency and the hum noise frequency are equals to each other in the following description. For a hum noise frequency of 50 Hz, the power-source frequency is 50 Hz for instance. For a hum noise frequency of 60 Hz, the power-source frequency is 60 Hz for instance.

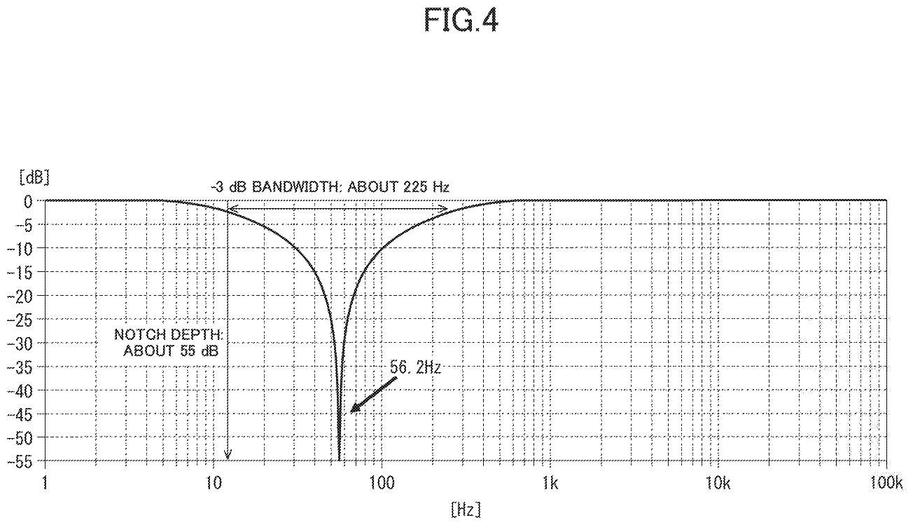

The first NF 130-1 is provided in the ion detector 1 in order to eliminate a hum noise of 50 or 60 Hz. Accordingly, fN1 is set with reference to 50 or 60 Hz. By way of example only, fN1 needs to be set to 50 to 60 Hz (c.f., FIG. 4, which will be described later on). The hum-noise frequency is close to the lower limit of the discharge frequency band. The hum noise is a particularly large component among the other noises. It is hence particularly important for the first NF 130-1 to prevent the hum noise.

In addition to the hum noise, a noise inherent to the product (i.e., a noise inherent to the ion generator 100) occurs in the ion generator 100. This noise inherent to the product will be hereinafter referred to as a product-inherent noise. By way of example only, the product-inherent noise has a frequency (hereinafter referred to as product-inherent frequency) higher than the hum frequency. For instance, the ion generator 100 includes multiple LEDs in order to visually notify a user of the operation status of the ion generator 100. The LEDs are mostly lit on by dynamic drive using pulse-width-modulation (PWM) control.

Hence in the ion generator 100, a product-inherent noise occurs, which is a noise resulting from the LED dynamic drive. The product-inherent frequency depends on, for instance, harmonic components contained in the waveform of a PWM current that is applied to the LEDs. The product-inherent frequency ranges from several hundreds of hertz to several kilohertz for instance. FIG. 2 illustrates an instance where the product-inherent frequency is 400 Hz and 1200 Hz.

The ion detector 1 includes the second NF 130-2 in order to eliminate a product-inherent noise of 400 Hz (hereinafter referred to as a first product-inherent noise). Accordingly, fN2 is set with reference to 400 Hz. By way of example only, fN2 needs to be set to 300 to 500 Hz. Since the frequency of the first product-inherent noise belongs to the discharge frequency band, it is important for the second NF 130-2 to prevent the first product-inherent noise.

The ion detector 1 further includes the third NF 130-3 in order to eliminate a product-inherent noise of 1200 Hz (hereinafter referred to as a second product-inherent noise). Accordingly, fN3 is set with reference to 1200 Hz. By way of example only, fN3 needs to be set to 1100 to 1300 Hz. Since the frequency of the second product-inherent noise is close to the upper limit of the discharge frequency band, it is important for the third NF 130-3 to prevent the second product-inherent noise.

As described above, the NF circuit 13 preferably includes at least one additional NF (in other words, at least one BEF) different from the first NF 130-1. Both the second NF 130-2 and third NF 130-3 are examples of the at least one additional NF. In the first preferred embodiment, the second to P^{th} NFs fall under the at least one additional NF.

In the first preferred embodiment, each of the second to P^{th} NFs needs to have a cutoff frequency band whose reference frequency (i.e., fN2 to fNP) is set to be (i): lower than 50 Hz. or (ii): higher than 60 Hz. The second to P^{th} NFs need to have their cutoff frequency bands different from one another. The cutoff frequency bands of the second to P^{th} NFs may partly overlap each other.

In the ion generator 100, there is a noise in a frequency band having a higher frequency than the product-inherent frequency. By way of example only, the radiation from the transformer within the discharge circuit causes a noise in a frequency band of several hundreds of kilohertz or more (e.g., 200 kHz or more). The noise caused by the radiation from the transformer will be hereinafter referred to as a radiation noise. In addition, the frequency of the radiation noise will be hereinafter referred to as radiation frequency.

The ion detector 1 includes the LPF 141 in order to eliminate the radiation noise. FIG. 2 illustrates an instance where fBP1 (i.e., the cutoff frequency of the LPF 141) is set to 200 kHz. That is, the LPF 141 is configured to cut off a signal having a frequency component of 200 kHz or more. By way of example only, fBP1 needs to be set to 200 kHz or more.

The ion detector 1 includes the HPF 142 in order to eliminate a low-frequency component contained V0 (i.e., a low-frequency noise), particularly a direct-current (DC) component contained in V0. By way of example only, fBP2 (i.e., the cutoff frequency of the HPF 142) is set to 10 Hz. The HPF 142 can prevent an unnecessary component (i.e., a DC component) from being contained in a signal (i.e., V2) that is input to the H comparator 15. Here, fBP2 needs to be set to a value near 0 Hz so as to be suitable for eliminating the DC component.

As described above, the first to Q^{th} BPFs each need to have a cutoff frequency (i.e., fBP1 to fBPQ) that is set to be (i): lower than 50 Hz, or (ii) higher than 60 Hz.

Exemplary Configuration of NF 130

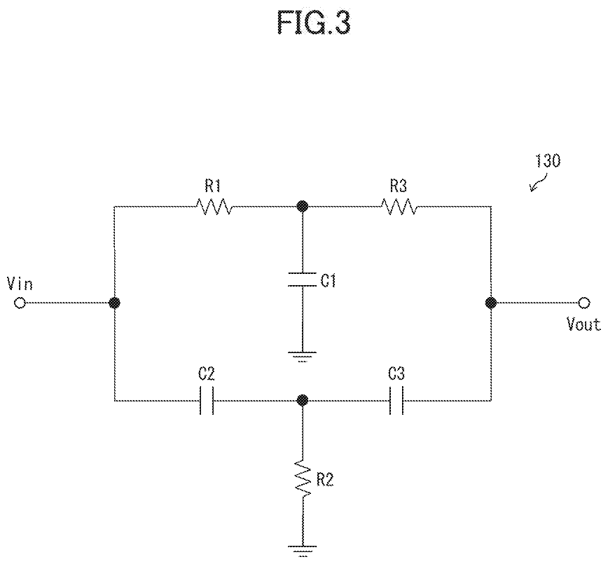

FIG. 3 illustrates an example of the configuration of the NF 130. In FIG. 3 and the subsequent drawings, Vin denotes an input voltage or input signal, and Vout denotes an output voltage or output signal. In the example in FIG. 3, Vin corresponds to V1, and Vout corresponds to V2. In FIG. 3 and the subsequent drawings, the alphabet R denotes a resistance, the alphabet C denotes a capacitor, and the alphabet L denotes a coil or inductor. These elements in the drawings (i.e., resistors, capacitors, and coils) are denoted by the respective alphabets along with mutually different indexes, and are thus distinct from one another. In expressing the circuit constant of a certain element, a sign identical to that used for the certain element will be used.

In the example in FIG. 3, the NF 130 consists of three resistors R1, R3, and R3, and three capacitors C1, C2, and C3. By way of example only, each element in the first NF 130-1 has a resistance and capacitance set as follows:
R1=27 kΩ,
R2=15 kΩ,
R3=27 kΩ,
C1=0.22 μF,
C2=0.1 μF, and
C3=0.1 μF.

Exemplary Frequency Characteristics of First NF 130-1

FIG. 4 is a graph showing one example of a gain characteristic of the first NF 130-1. To be more specific, FIG. 4 shows the gain characteristic of the first NF 130-1 with its elements (i.e., R1 to C3) having their above set values. As shown in FIG. 4, fN1=56.2 Hz is satisfied. In addition, the notch depth of the first NF 130-1, that is, the difference between 0 dB and the gain in fN1 (i.e., minimum gain), is about 55 dB.

In the Specification, the width (i.e., bandwidth) of the cutoff frequency band of the first NF 130-1 will be expressed using the −3 dB bandwidth of the gain characteristic. As shown in FIG. 4, the −3 dB bandwidth of the first NF 130-1 is about 225 Hz.

The first NF 130-1 having the aforementioned set gain characteristic can eliminate a hum noise of 50 or 60 Hz suitably. The first NF 130-1 can eliminate such a hum noise, particularly in both Case 1: a power-source frequency of 50 Hz, and Case 2: a power-source frequency of 60 Hz. That is, the first NF 130-1 can be designed in a common way in both Cases 1 and 2. The first NF 130-1 in the example in FIG. 4 is thus suitable for cost reduction in the ion detector 1. For this reason, fN1 is preferably set to 50 to 60 Hz.

Exemplary Configuration of H Comparator 15

FIG. 5 illustrates the configuration of the H comparator 15. In the example in FIG. 5, Vin corresponds to V2, and Vout corresponds to Cout. The H comparator 15 in FIG. 5 is an example of a non-inverting H comparator.

The H comparator 15 consists of the operational amplifier 151 and three resistors R1, R2, and Rp. It is noted that the resistors R1 and R2 in FIG. 5 are different from the resistors R1 and R2 in FIG. 3. The operational amplifier 151 has a negative input terminal to which Vref is input. The operational amplifier 151 has a positive input terminal to which Vin is input via the resistor R1.

The operational amplifier 151 has a positive power-supply terminal to which a positive power-supply voltage, which is hereinafter abbreviated to V₊, is input. The operational amplifier 151 has a negative power-supply terminal to which a negative power-supply voltage, which is hereinafter abbreviated to V₋, is input. By way of example only, V₊=5 V is satisfied, and V₋=0 V is satisfied. V₊ corresponds to high-level Cout, and V₋ corresponds to low-level Cout.

In the H comparator 15, Vin is provided with two thresholds. The greater one of the thresholds will be referred to as VTH1 (i.e., a first threshold), and the smaller one will be referred to as VTH2 (i.e., a second threshold). VTH1 may be referred to as a high-level threshold, and VTH2 may be referred to as a low-level threshold.

To be specific, VTH1 is a threshold that is employed in a Vin rise from LOW to HIGH. In the H comparator 15 in FIG. 5. VTH1 is expressed by Expression 1 below.

$$\begin{matrix}Expression 1 & \\ {V}_{TH 1} = ( 1 + \frac{{R}_{1}}{{R}_{2}} ) {V}_{ref} - \frac{{R}_{1}}{{R}_{2}} {V}_{-} & ( 1 )\end{matrix}$$

Moreover, VTH2 is a threshold that is employed in a Vin drop from HIGH to LOW. In the H comparator 15 in FIG. 5. VTH2 is expressed by Expression 2 below.

$$\begin{matrix}Expression 2 & \\ {V}_{TH 2} = ( \frac{{R}_{p} + {R}_{1} + {R}_{2}}{{R}_{p} + {R}_{2}} ) {V}_{ref} - \frac{{R}_{1}}{( {R}_{p} + {R}_{2} )} {V}_{+} & ( 2 )\end{matrix}$$

VTH1 and VTH2 are set based on Vref, as indicated in Expressions 1 and 2.

In the H comparator 15 in FIG. 5, Vref is set to 0.455 V for instance. In addition, R1 is set to 1 kΩ, R2 is set to 3 kΩ, and Rp is set to 10 kΩ. In this case. VTH1=0.606 V is satisfied based on Expression 1. In addition, VTH2=0.105 V is satisfied based on Expression 2. Accordingly, VTH2<Vref<VTH1 is satisfied in this example.

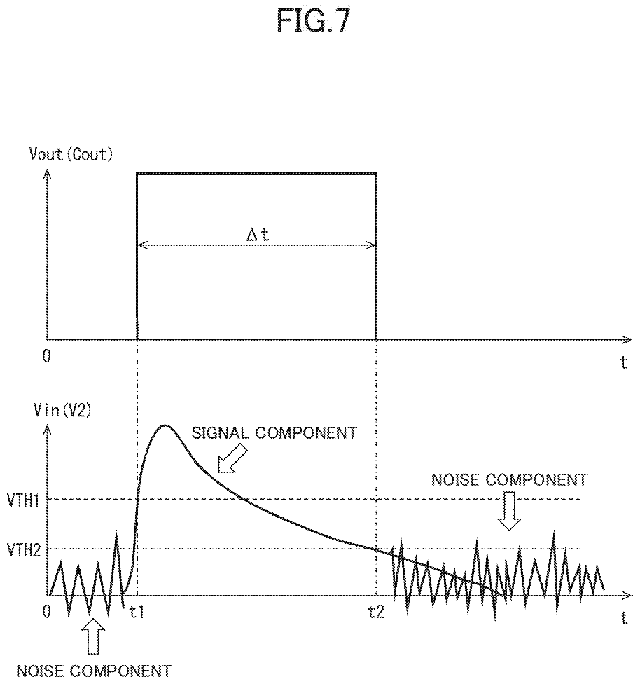

FIG. 6 is a graph for describing an input-output characteristic (i.e., hysteresis characteristic) of the H comparator 15. FIG. 6 illustrates an instance where Vin forms delta-shaped waves. The delta-shaped waves schematically indicate the actual pulse waveform of Vin indicated in FIG. 7, which will be described later on. FIG. 6 shows the relationship between Vin and Vout. Reference is made to the first delta-shaped wave of Vin. The period of Vin will be hereinafter expressed as a cycle T. The cycle T will be also referred to a Vin pulse width (i.e., input pulse width).

Vin is 0 V (which is a minimum value) at the initial time (i.e., t=0). Vin, starting from the initial time, linearly increases with time from 0 V to a peak value (referred to as Vinmax for convenience). The time at which Vin equals Vinmax will be hereinafter referred to as a time tm. In the example in FIG. 6, tm=T/2 is satisfied. In addition, Vinmax is set to be greater than VTH1.

The time at which Vin equals VTH1 in a period of Vin increase will be hereinafter referred to as a time t1. The H comparator 15 applies VTH1, one of the two thresholds, until the time t1 (i.e., until Vin equals VTH1). To be specific, for Vin<VTH1, the H comparator 15 outputs Vout that is herein V₋ (=0 V). For Vin≥VTH1, the H comparator 15 outputs Vout that is herein V₊ (=5 V). There are operation modes for the H comparator 15. One of the modes is a first mode (or high-level threshold mode) in which VTH1 is employed.

The other operation mode is a second mode (or low-level threshold mode), which will be described later on. The H comparator 15 operates in the second mode after the time t1 until Vin equals VTH2 (i.e., until a time t2, which will be described later on).

FIG. 6 clearly shows that t1<tm<t2 is satisfied. Moreover, VTH1>VTH2 is satisfied as described above. The following are satisfied in the foregoing voltage-rise period:
0≤t≤t1 . . . Vout=0 V, and
   t1≤t≤tm . . . Vout=5 V.

Reference is now made to a Vin decrease period. Vin, starting from the time tm, linearly decreases with time from Vinmax to 0 V. That is, Vin equals 0 V in t=T. The aforementioned time t2 is a time at which Vin equals VTH2 in this decrease period.

As described above, VTH2 is employed, which is the other of the two thresholds, in the decrease period until the time t. To be specific, for Vin≥VTH2, the H comparator 15 outputs Vout that is herein V₊. For Vin<VTH2, the H comparator 15 outputs Vout that is herein V₋. VTH2 is employed in the aforementioned second mode, which is the other operation mode of the H comparator 15. The operation mode of the H comparator 15 shifts again to the first mode after the time t2.

Accordingly, the following are satisfied in the Vin-drop period:
tm≤t≤t2 . . . Vout=5 V, and
t2<t≤T . . . Vout=0 V.

Accordingly, Vout changes according to V in a single cycle of Vin, where the following are satisfied:
0≤t<t1 . . . Vout=0 V,
t1≤t≤t2 . . . Vout=5 V, and
t2<t≤T . . . Vout=0 V.

Upon receiving the delta-shaped wave Vin having a pulse width T, the H comparator 15 outputs rectangular wave Vout having a pulse width Δt. Here, Δt=t2−t1 is satisfied. The pulse width Δt is also referred to as an output pulse width. Moreover, VHYS=VTH1−VTH2 is satisfied, where VHYS indicates the hysteresis width of Vin. As described above, the H comparator 15 is provided with a hysteresis characteristic of the output signal with respect to the input signal.

Example of Actual Input-Output Waveform in H Comparator 15

FIG. 7 is a graph schematically showing the actual input-output waveform in the H comparator 15. Like FIG. 6. FIG. 7 shows the relationship between Vin (i.e., V2) and Vout (i.e., Cout). As shown in FIG. 7, a pulse of Vin is generated by an electric discharge of the ion generator 100. This pulse corresponds to a signal component (i.e., discharge signal) of Vin. As shown in FIG. 7, a noise component of Vin is dominant before Vin pulse rise and after Vin pulse drop.

As wide an output pulse width (denoted by Δt) as possible is preferably obtained, in order to detect an electric discharge in the ion generator 100 with more certainty. The H comparator 15 is accordingly configured such that VTH1 is set to be greater than the peak value (or expected value) of the noise component, as shown in FIG. 7. The H comparator 15 is also configured such that VTH2 is set to be smaller than the expected value.

The waveform of the discharge signal is similar to a typical discharge pulse waveform. That is, Vin rises abruptly upon discharge start, as shown in FIG. 7. Vin then drops relatively gently upon discharge end. That is, unlike the example in FIG. 6, the period of Vin rise is shorter than the period of Vin drop in the actual ion generator 100.

Since VTH1 can be employed in the Vin rise period, the H comparator 15 can particularly prevent noise effects in this rise period effectively. In addition, since Vin rises abruptly, the time t1 is, in the rise period, relatively close to the time point at which Vin equals VTH2. That is, the time t1 does not increase very much when VTH1 is employed. This can avoid decrease in the pulse width Δt.

In the H comparator 15, VTH2 can be employed in the Vin drop period, which is subsequent to the Vin rise period. The time t2 can be accordingly set to a large value. That is, the pulse width Δt can be greater. In addition, employing VTH2 can prevent noise effects in the Vin drop period.

As described above, using the H comparator 15 provides two things: (i) Vout with a particularly high noise resistance, and (ii) a sufficiently wide output pulse width.

Effects

Japanese Patent Application Laid-Open No. 2017-50196 discloses cutting off a noise contained in V0 (i.e., a first detected signal) in the ion detector using BPFs (e.g., an LPF and an HPF). That is, Japanese Patent Application Laid-Open No. 2017-50196 discloses performing the second frequency filtering on V0.

As earlier described, V0 contains various kinds of noise for the discharge signal. V0 contains a hum noise for instance. Japanese Patent Application Laid-Open No. 2017-50196 however fails to describe particular countermeasures against the hum noise. In other words, Japanese Patent Application Laid-Open No. 2017-50196 is silent about providing a filter (e.g., an NF) for hum-noise elimination.

For instance, the cutoff frequency of an LPF can be set in the ion detector in Japanese Patent Application Laid-Open No. 2017-50196 in such manner that the hum noise is eliminated. As earlier described with reference to FIG. 2 however, a hum frequency is relatively close to a discharge frequency band. Hence, the LPF of the ion detector in Japanese Patent Application Laid-Open No. 2017-50196 eliminates a discharge signal (which is a signal that should be obtained for ion detection) as well when eliminating the hum noise. The ion detector consequently cannot detect the state of ion generation properly.

As earlier described, V0 also contains a product-inherent noise (i.e., at least one of the first and second product-inherent noises) other than the hum noise. Japanese Patent Application Laid-Open No. 2017-50196 however fails to describe particular countermeasures against the product-inherent noise. Japanese Patent Application Laid-Open No. 2017-50196 is silent about providing a filter (e.g., an NF) for eliminating the product-inherent noise.

As earlier described, a product-inherent frequency is relatively close to a discharge frequency band. The product-inherent frequency belongs to the discharge frequency band in some cases. Hence, when the LPF of the ion detector in Japanese Patent Application Laid-Open No. 2017-50196 eliminates the product-inherent noise for instance, a problem arises that is similar to that in the hum-noise elimination using the LPF.

As described above, the inventor of the present application has considered that a conventional noncontact ion detector requires specific improvements for increasing detection accuracy (to be more specific, ion detection accuracy). The ion detector 1 has newly devised based on this inventor's idea.

The ion detector 1 includes the NF circuit 13, unlike the ion detector in Japanese Patent Application Laid-Open No. 2017-50196. The NF circuit 13 can thus eliminate a hum noise selectively (or more precisely) using the first NF 130-1. Likewise, the NF circuit 13 can eliminate a product-inherent noise selectively using at least one additional NF (e.g., the second NF 130-2 and third NF 130-3).

As described above, the NFs each have a sufficiently narrow cutoff frequency band, unlike the BPFs. This can suitably avoid attenuation in a discharge signal when each NF eliminates the hum noise and product-inherent noise. That is. V2 (i.e., a post-filtering first detected signal), containing a discharge signal mainly, can be obtained.

In this way, the ion detector 1, which includes the NF circuit 13, achieves detection accuracy higher than that of a conventional noncontact ion detector (e.g., the ion detector in Japanese Patent Application Laid-Open No. 2017-50196).

The ion detector 1 further includes the H comparator 15, unlike the ion detector in Japanese Patent Application Laid-Open No. 2017-50196. Providing the H comparator 15 enables V2 (i.e., the post-filtering first detected signal), which is an analog signal, to be converted into Cout (i.e., a second detected signal), which is a digital signal.

As shown in FIG. 7, converting the analog signal (i.e. V2) to the digital signal (i.e., Cout) can further eliminate a noise contained in the analog signal. In other words, the digital signal can be more resistant against noise than the analog signal can be. Using Cout as an output detected signal can hence further enhance the detection accuracy of the ion detector 1 (that is, the possibility of erroneous detection in the ion detector 1 can be further reduced). In particular, supplying Cout to the control circuit 70 can prevent a malfunction of the control circuit 70 (e.g., an inappropriate operation based on the erroneous detection) more effectively.

### SUPPLEMENTAL NOTES

(1) FIG. 1 has illustrated a configuration where the frequency filtering circuit 125 includes the NF circuit 13 anterior to the BPF circuit 14 (i.e., at an input stage). In the frequency filtering circuit 125, the NF circuit 13 can be posterior to the BPF circuit 14.

That is, in the frequency filtering circuit 125, the first frequency filtering may be performed after the second frequency filtering. This is because since the NF circuit 13 and BPF circuit 14 have mutually different frequency characteristics, which comes first between the first and second frequency filtering does not affect V2 ideally.

In the foregoing example, the BPF circuit 14, which serves as an input unit of the frequency filtering circuit 125, receives V0 from the conversion circuit 12. In addition, the NF circuit 13, which serves as an output unit of the frequency filtering circuit 125, supplies V2 to the positive input terminal of the H comparator 15. The frequency filtering circuit 125 of the ion detector 1 in this way need to be placed in a location that is posterior to the conversion circuit 12 and is anterior to the H comparator 15.

(2) For the same reason set forth in the foregoing example, which comes first between the NFs of the NF circuit 13 is not limited to the example in FIG. 1. Likewise, which comes first between the BPFs of the BPF circuit 14 is not limited to the example in FIG. 1.

(3) The first preferred embodiment has described an instance where the first detected signal is V0, which is a voltage signal. The first detected signal can be also I0, which is a current signal. That is, the detection electrode I1 can be used as a detection unit. The conversion circuit 12 can be omitted in this case. The frequency filtering circuit 125 accordingly performs frequency filtering on I0 to output the post-filtering first detected signal, which is a current signal.

Nevertheless, a voltage signal is preferably used as the first detected signal. This is because in most cases, a voltage signal probably has a signal level higher than that of a current signal. It is hence preferable that a voltage signal be used as the first detected signal in order to enhance ion detection accuracy.

Modifications

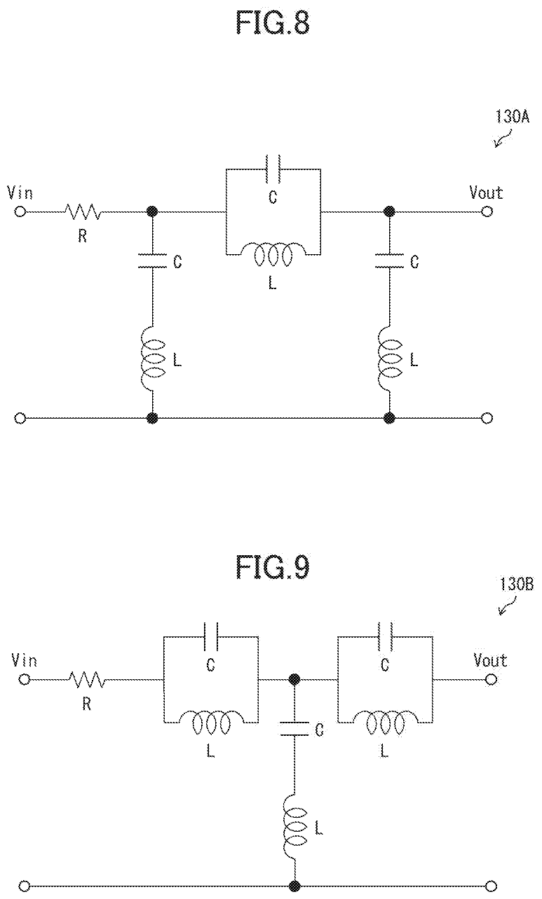

The first preferred embodiment has described an instance where an NF is used as a BEF. In some preferred embodiments, a publicly known, typical BEF can be also used instead of the NFs described in the first preferred embodiment. For instance, FIGS. 8 and 9 illustrate usable BEFs.

FIG. 8 illustrates the configuration of a BEF according to a modification. FIG. 8 shows a BEF 130A, which is also referred to as a π-BEF. FIG. 9 illustrates the configuration of a BEF according to another modification. FIG. 9 shows a BEF 130B, which is also referred to as a T-BEF. An ion detector that includes such BEFs achieves detection accuracy higher than that of a conventional ion detector, as is the case with the ion detector in the first preferred embodiment.

Nevertheless, an NF is preferably used as a BEF in order to further enhance the detection accuracy of the ion detector 1. This is because the cutoff frequency band of the NF is narrower than that of a typical BEF. The NF can cut off a target noise (e.g., a hum noise) more precisely. That is, the NF can avoid attenuation of a discharge signal more effectively than a typical BEF.

### Second Preferred Embodiment

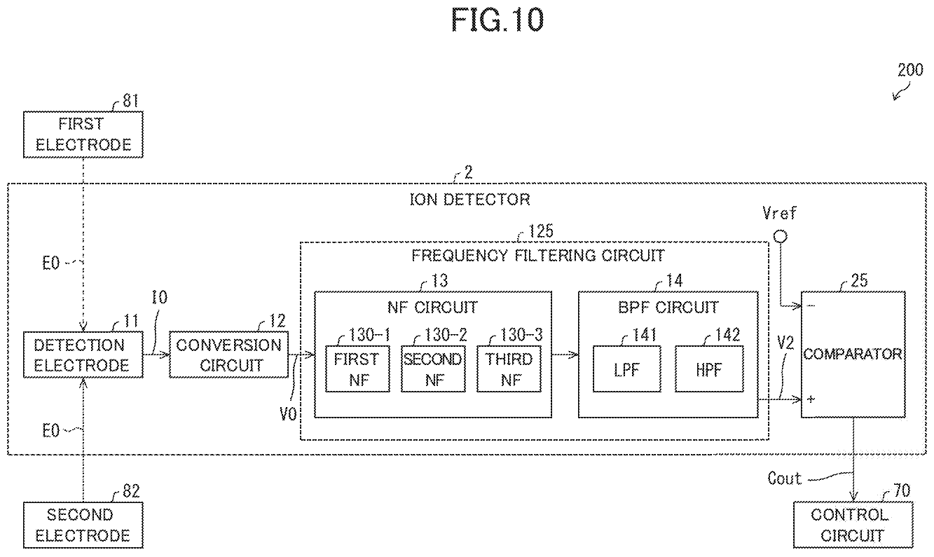

FIG. 10 is a block diagram illustrating the configuration of main components of an ion generator 200 according to a second preferred embodiment. The second preferred embodiment describes an ion detector 2. The ion detector 2 includes a comparator 25 instead of the H comparator 15, which is included in the ion detector 1.

The comparator 25 is a typical comparator having no hysteresis characteristics. The comparator 25 may be also referred to as a non-hysteresis comparator (or non-H comparator). Unlike the H comparator 15, the comparator 25 outputs Cout according to V2 using a single threshold, abbreviated to Vref. The following description about the comparator 25 can read Vin as V2 and read Vout as Cout, as is the case with the first preferred embodiment.

To be specific, for Vin≥Vref, the comparator 25 outputs Vout that is herein V₊. In addition, for Vin<Vref, the comparator 25 outputs Vout that is herein V₋. Like the H comparator 15, the comparator 25, which can generate Cout (i.e., a digital signal), enables the ion detector 2 to have detection accuracy higher than that of a conventional ion detector, as is the case with the ion generator in the first preferred embodiment.

Using the comparator 25 instead of the H comparator 15 achieves a less expensive ion detector than using the comparator described in the first preferred embodiment. Nevertheless, the H comparator 15 is preferably used in order to further enhance the noise resistance of Cout (that is, in order to further increase the detection capability of the ion detector), as described above.

A person who designs the ion detector may select, as appropriate, which to use, either the H comparator 15 or the comparator 25 by reflecting costs and detection accuracy required for the ion detector.

### Third Preferred Embodiment

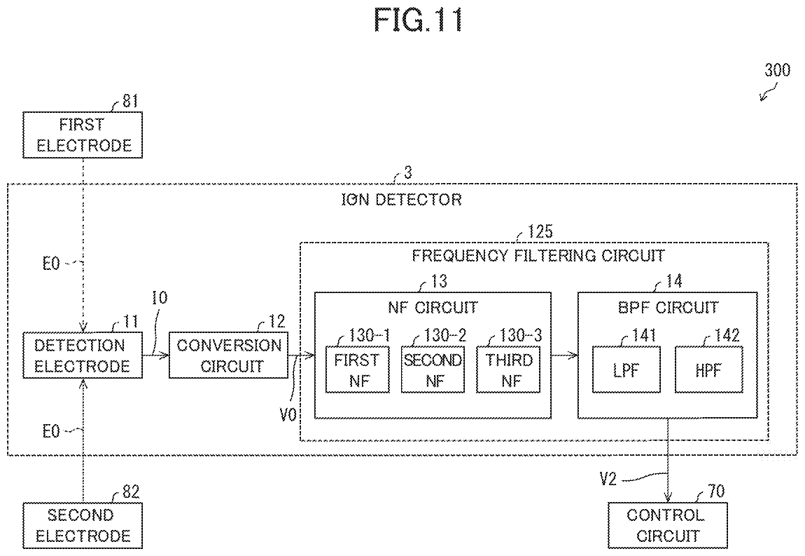

FIG. 11 is a block diagram illustrating the configuration of main components of an ion generator 300 according to a third preferred embodiment. The third preferred embodiment describes an ion detector 3. Unlike the ion detector 2, the ion detector 3 does not include the comparator 25. In the ion detector 3, the frequency filtering circuit 125 supplies V2 to the control circuit 70.

As described above, V2 consists of V0 that has undergone frequency filtering in the frequency filtering circuit 125 to sufficiently eliminate noise components contained therein. V2 can be thus used as an output detected signal, instead of Cout. The ion detector 3 achieves detection accuracy higher than that of a conventional ion detector.

The ion detector in the third preferred embodiment, which does not include the comparator 25, can be less expensive than the ion detector in the second preferred embodiment. The configuration of the ion detector 3 may be applied to an ion detector that does not require very high detection accuracy.

### Reference Preferred Embodiments

As described above, an ion detector according to an aspect of the present invention includes a comparator (preferably, an H comparator), thus achieving a high detection capability. The ion detector according to the aspect of the present invention can hence omit a BEF circuit (e.g., an NF circuit) as long as it includes a comparator. This is because this ion generator can have a detection capability higher than that of a conventional ion detector in this case as well.

The frequency filtering circuit in this case supplies V1 to the comparator as a post-filtering first detected signal. The comparator then generates Cout based on V1. The ion detector according to the aspect of the present invention can be accordingly expressed as indicated below.

The ion detector according to the aspect of the present invention is installed in an ion generator. The ion detector includes the following: a detection unit that acquires a first detected signal corresponding to a change in an electric field caused by an electric discharge of the ion generator, a frequency filtering circuit that performs frequency filtering on the first detected signal to output a post-filtering first detected signal, and a comparator that acquires the post-filtering first detected signal. The frequency filtering circuit includes at least one band-pass filter. The comparator evaluates the value of the post-filtering first detected signal based on a predetermined reference value, to output a second detected signal that is a digital signal corresponding to the post-filtering first detected signal.

Example Implemented By Software

The control blocks of the ion generators 100 to 300 (in particular, the control circuit 70) may be implemented by a logic circuit (i.e., hardware) provided in an integrated circuit (i.e., an IC chip) or by software.

For software, the ion generators 100 to 300 each include a computer that executes commands of a program (which is software) for implementing individual functions. This computer includes, but not limited to, at least one processor (i.e., controller) and at least one computer-readable recording medium storing the program. The processor in the computer reads the program from the recording medium and then executes the program, thus achieving the object of the aspect of the present invention. As the processor, a central processing unit (CPU) can be used for instance. An example of the recording medium usable hrein is a non-transitory tangible medium, including a read only memory (ROM), a tape, a disk, a card, a semiconductor memory, and a programmable logic circuit. The computer may further include a component, such as a random access memory (RAM) that deploys the program. The program may be supplied to the computer via any transmission medium (such as a communication network or a broadcast wave) that can transmit the program. An aspect of the present invention can be achieved in the form of a data signal embedded in a carrier wave, with the program embodied by electronic transmission.

### SUMMARY

A first aspect of the present invention provides an ion generator (1) that is installed in an ion generator (100). The ion detector includes the following: a detection unit (e.g., the conversion circuit 12) that acquires a first detected signal (V0) corresponding to a change in an electric field (E0) caused by an electric discharge of the ion generator, and a frequency filtering circuit (125) that performs frequency filtering on the first detected signal to output a post-filtering first detected signal (e.g., V2). The frequency filtering circuit includes at least one band-pass filter (e.g., the BPF circuit 14) and at least one band-elimination filter (e.g., the NF circuit 13). The at least one band-elimination filter has a frequency characteristic different from the frequency characteristic of the at least one band-pass filter.

The above configuration enables frequency filtering, that is, both the first frequency filtering (e.g., frequency filtering in the NF circuit 13) and the second frequency filtering (e.g., frequency filtering in the BPF circuit 14), to be performed.

Accordingly, the ion detector can more precisely eliminate a frequency component to be filtered, through the first frequency filtering, unlike a conventional noncontact ion detector (e.g., an ion detector that performs the second frequency filtering alone). The ion detector consequently achieves a detection capability higher than that of the conventional ion detector.

The ion detector according to a second aspect of the present invention is preferably configured, in the first aspect, such that the frequency filtering circuit includes a first band-elimination filter (e.g., the first NF 130-1) as the at least one band-elimination filter, and such that the first band-elimination filter has a cutoff frequency band whose reference frequency (e.g., fN1) is 50 Hz or more and 60 Hz or less.

As earlier described, it is difficult for the conventional ion detector to eliminate a hum noise (e.g., a noise of 50 or 60 Hz) precisely. The above configuration enables the first band-elimination filter to eliminate the hum noise more precisely.

The ion detector according to a third aspect of the present invention is preferably configured, in the second aspect, such that the frequency filtering circuit includes at least one additional band-elimination filter different from the first band-elimination filter, and such that the at least one additional band-elimination filter includes a plurality of additional band-elimination filters (e.g., the second NF 130-2 and third NF 130-3) each having a cutoff frequency band whose reference frequency is (i): lower than 50 Hz, or (ii): higher than 60 Hz.

As earlier described, it is difficult for the conventional ion detector to eliminate a product-inherent noise precisely. The above configuration enables the at least one additional band-elimination filter to eliminate the product-inherent noise more precisely.

The ion detector according to a fourth preferred embodiment of the present invention is preferably configured, in the third aspect, such that the at least one additional band-elimination filter includes second and third band-elimination filters (e.g., the second NF 130-2 and third NF 130-3) having mutually different cutoff frequency bands.

The above configuration enables the additional band-elimination filter to eliminate respective product-inherent noises (e.g., the first and second product-inherent noises) more precisely.

The ion detector according to a fifth aspect of the present invention is preferably configured, in any one of the second to fourth aspects, such that the at least one band-pass filter (e.g., the LPF 141 and HPF 142) has a cutoff frequency that is (i): lower than 50 Hz, or (ii): higher than 60 Hz.

The above configuration enables the band-pass filter to further eliminate a noise (or DC component).

The ion detector according to a sixth aspect of the present invention is preferably configured, in any one of the first to fifth aspects, such that the frequency filtering circuit includes at least one notch filter as the at least one band-elimination filter.

The above configuration, which uses a notch filter as the band-elimination filter, enables a frequency component to be filtered and thus eliminated more precisely in the first frequency filtering.

In any one the first to sixth preferred embodiments, the ion detector according to a seventh aspect of the present invention preferably further includes a comparator (15) that acquires the post-filtering first detected signal. The comparator evaluates the value of the post-filtering first detected signal based on a predetermined reference value, to output a second detected signal (Cout) that is a digital signal corresponding to the post-filtering first detected signal.

The above configuration enables the comparator to output a signal (i.e., an output detected signal) that indicates a result detected by the ion detector, and that is highly resistant to noise (i.e., Cout, which is a digital signal), instead of V2 (i.e., the post-filtering first detected signal), which is an analog signal. This can further reduce possible erroneous detection in the ion detector, thereby much further increasing the detection capability of the ion detector.

The ion detector according to an eighth aspect of the present invention is preferably configured, in the seventh aspect, such that the comparator is a hysteresis comparator (25), and such that the hysteresis comparator is provided with a first threshold (VTH1) and a second threshold (VTH2) smaller than the first threshold. The first and second thresholds are set based on the reference value.

The above configuration, which uses a hysteresis comparator as the comparator, enables Cout to be output that is further highly resistant to noise. The hysteresis comparator is particularly suitable to be used for the post-filtering first detected signal containing a discharge signal as a signal component, as earlier described.

The ion detector according to a ninth aspect of the present invention may be configured, in any one of the first to eighth aspects, such that the post-filtering first detected signal is sectioned into a signal component and a noise component, and such that the signal component has a signal-rise period and a signal-drop period. The signal-rise period may be shorter than the signal-drop period.

A tenth aspect of the present invention provides an ion generator that preferably includes the ion detector according to any one of the first to ninth aspects.

### ADDITIONAL NOTE

An aspect of the present invention is not limited to what have been described in the individual preferred embodiments. Various modifications can be made within the scope of the claims. A preferred embodiment obtained in combination, as necessary, with the technical means disclosed in the respective preferred embodiments is included within the technical scope of the aspect of the present invention as well. Furthermore, combining the technical means disclosed in the respective preferred embodiments can form a new technical feature.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An ion detector that is installed in an ion generator, the ion detector comprising:
a detection unit configured to acquire a first detected signal corresponding to a change in an electric field caused by an electric discharge of the ion generator; and
a frequency filtering circuit configured to perform frequency filtering on the first detected signal to output a post-filtering first detected signal,
wherein the frequency filtering circuit comprises at least one band-pass filter and at least one band-elimination filter, the at least one band-elimination filter having a frequency characteristic different from a frequency characteristic of the at least one band-pass filter.

2. The ion detector according to claim 1, wherein
the frequency filtering circuit comprises a first band-elimination filter as the at least one band-elimination filter, and
the first band-elimination filter has a cutoff frequency band whose reference frequency is 50 Hz or more and 60 Hz or less.

3. The ion detector according to claim 2, wherein
the frequency filtering circuit comprises at least one additional band-elimination filter different from the first band-elimination filter, and
the at least one additional band-elimination filter comprises a plurality of additional band-elimination filters each having a cutoff frequency band whose reference frequency is lower than 50 Hz, or higher than 60 Hz.

4. The ion detector according to claim 3, wherein the at least one additional band-elimination filter comprises second and third band-elimination filters having mutually different cutoff frequency bands.

5. The ion detector according to claim 2, wherein the at least one band-pass filter has a cutoff frequency that is lower than 50 Hz, or higher than 60 Hz.

6. The ion detector according to claim 1, wherein the frequency filtering circuit comprises at least one notch filter as the at least one band-elimination filter.

7. The ion detector according to claim 1, further comprising a comparator configured to acquire the post-filtering first detected signal,
wherein the comparator evaluates a value of the post-filtering first detected signal based on a predetermined reference value, to output a second detected signal that is a digital signal corresponding to the post-filtering first detected signal.

8. The ion detector according to claim 7, wherein
the comparator comprises a hysteresis comparator, and
the hysteresis comparator is provided with a first threshold and a second threshold smaller than the first threshold, the first and second thresholds being set based on the predetermined reference value.

9. The ion detector according to claim 1, wherein
the post-filtering first detected signal is sectioned into a signal component and a noise component, and
the signal component has a signal-rise period and a signal-drop period, the signal-rise period being shorter than the signal-drop period.

10. An ion generator comprising the ion detector according to claim 1.
